(19) United States
(12) Patent Application Publication
(10) Pub. No.: US 2016/0358508 A1
(43) Pub. Date: Dec. 8, 2016

(54) SMART REFRIGERATOR

(71) Applicant: Elwha LLC, Bellevue, WA (US)

(72) Inventors: Jesse R. Cheatham, III, Seattle, WA (US); Eun Young Hwang, Sausalito, CA (US); Roderick A. Hyde, Redmond, WA (US); Max N. Mankin, Cambridge, MA (US); Tony S. Pan, Bellevue, WA (US); Clarence T. Tegreene, Mercer Island, WA (US); Victoria Y.H. Wood, Livermore, CA (US)

(21) Appl. No.: 14/731,794

(22) Filed: Jun. 5, 2015

(51) Int. Cl. G09B 19/00; G06K 9/00; G06K 7/10; H04N 7/18

(52) U.S. Cl. CPC G09B 19/0092; H04N 7/183; G06K 9/00013; G06K 7/10366; G06K 9/00288

(57) ABSTRACT

A food storage unit and method includes passively identifying a user of the food storage unit and logging one or more food acquisitions by the user. A container for use with the food storage unit includes means for determining an amount of food in the container and communicating this information to the food storage unit.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### Priority Applications:

None

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

In one aspect, a food storage system includes a storage unit (e.g., a refrigerator or a pantry) configured to hold a plural of food containers, an identification unit configured to passively determine an identity of a person accessing the storage unit, and a memory configured to store a log, the log including a plurality of entries of food acquisition incidents. The identification unit may include a camera (e.g., inside the storage unit) configured to image a person accessing the storage unit, for example to identify the person using facial recognition techniques, handprint recognition techniques, or comparison with a list of known persons, or to identify the type or quantity removed food (e.g., by recognizing the container or a visual characteristic of the food). The identification unit may include a handprint scanner, for example on a handle of the storage unit. The identification unit may include an RFID reader configured to identify an accessed food container. The identification unit may be configured to store an image corresponding to a person who cannot be identified in the log. The log may include an access time, an identity of the person accessing food, and an identification of the food removed, which may be obtained by a difference in an amount in a container (which may be automatically determined, for example by a scale or strain gage, manually determined by a counter on the container, or determined by a dispenser that measures an amount dispensed). The container may include a sensor such as a scale or strain gage that monitors an amount of food removed. Log entries may include a user ID (which may be passively determined or manually entered), a food type, a timestamp, or a food quantity. The food storage system may include a processor configured to maintain a running total of a nutrient (e.g., calories, carbohydrates, protein, fat, fiber, vitamins, minerals, fatty acids, or amino acids) removed from the refrigerator, for example of at least one user ID of a plurality of user IDs, and to generate a report (to the user accessing food or to a different user) if the running total exceeds or falls short of a target value. The log may be configured to output a list of entries, for example sorted by user ID. The memory may be configured to store logs for a plurality of storage units. The food storage system may further include a processor configured to access the log, to edit a log entry (e.g., by adding an entry or modifying an entry), and to return the edited log to memory. The food storage system may further include a lock configured to prevent access to the storage unit, for example to lock out a person who cannot be identified, a person known not to have permission to access food, a person accessing food at a time when it is not permitted, or a person who has already accessed a selected amount of food. A container of the plurality of food containers may include a lock configured to prevent access to the food in the container, for example to lock out a person who cannot be identified, a person known not to have permission to access food, a person accessing food at a time when it is not permitted, or a person who has already accessed a selected amount of food. The food storage system may further include a processor configured to monitor a quantity of food in the storage unit, which may be further configured to predict a time when the monitored quantity will reach zero, and to output the food to a grocery list before that time. The food storage system may further include a processor configured to provide a suggestion to a person accessing the unit, which may be based in part on the identity of the person or on a food selection made by the person. The system may further include an electronic communications module, which may be configured, for example, to receive or transmit identification information associated with an individual permitted to access the storage unit, or to receive or transmit at least potion of the log, for example from or to a remote entity.

In another aspect, a method of recording food consumption includes maintaining a storage unit holding a plurality of food containers, passively determining an identity of a person accessing the storage unit, and making an entry in a log including a record of a food acquisition incident. The method may further include refrigerating the plurality of food containers. Passively determining identity may include imaging the person, for example with a camera inside the storage unit, for example by comparing an image of the person to a list of persons with access permission (e.g., storing or transmitting the image if a match is not found), or by using handprint recognition technology (e.g., on a handle of the storage unit). Imaging the person may include identifying a type or quantity of food removed. Making an entry in the log may include recording access time, identity of the person accessing the unit, and a food removed from the unit. The unit may include a container with means for determining an amount of dispensed food, and the log entry may include the amount of dispensed food. Making a log entry may include allowing a user to manually enter a different user ID. The method may further include generating a running total of a nutrient (e.g., calories, carbohydrates, protein, fat, fiber, vitamins, minerals, fatty acids, or amino acids) in foods removed from the unit, for example by maintaining a running total for at least one user ID of a plurality of user IDs. The storage unit may include a lock, and the method may include unlocking the storage unit upon identification of an authorized user, or keeping the storage unit locked for an unauthorized or unidentifiable user (and optionally also storing the image of the unidentifiable user or sending it to a remote location) or for a user based on access history. The method may further include monitoring a quantity of food in the storage unit, and optionally predicting a time when the monitored quality will fall below a threshold, and outputting the monitored food to a grocery list at or before that time. The method may further include suggesting to a food to a person accessing the unit, for example using the identity of the person or a food selection made by the person.

In a further aspect, a food container for use with a food storage unit includes a container configured to hold food (e.g., a liquid or a solid food), a sensor configured to determine a quantity of food in the container, and a communication means configured to notify the food storage unit of changes in the quantity of food in the container. The sensor may be configured to determine a weight or a number of the food. The communication means may be configured to transmit a message to the storage unit, or to be passively interrogated by the storage unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a refrigerator.

FIG. 2 is a flow chart showing a method of tracking food consumption using the refrigerator of FIG. 1.

FIG. 3 is a container for use with the refrigerator of FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Consumers having restricted diets, and especially families, would like to have means for tracking food consumption that do not require extensive record keeping or monitoring of family members. The refrigerators and other food storage units described here allow tracking of calories and other nutrient consumption on a per person basis. In some embodiments, the refrigerators may “lock out” family members who have already consumed enough foods or who are trying to access the refrigerator at unauthorized times.

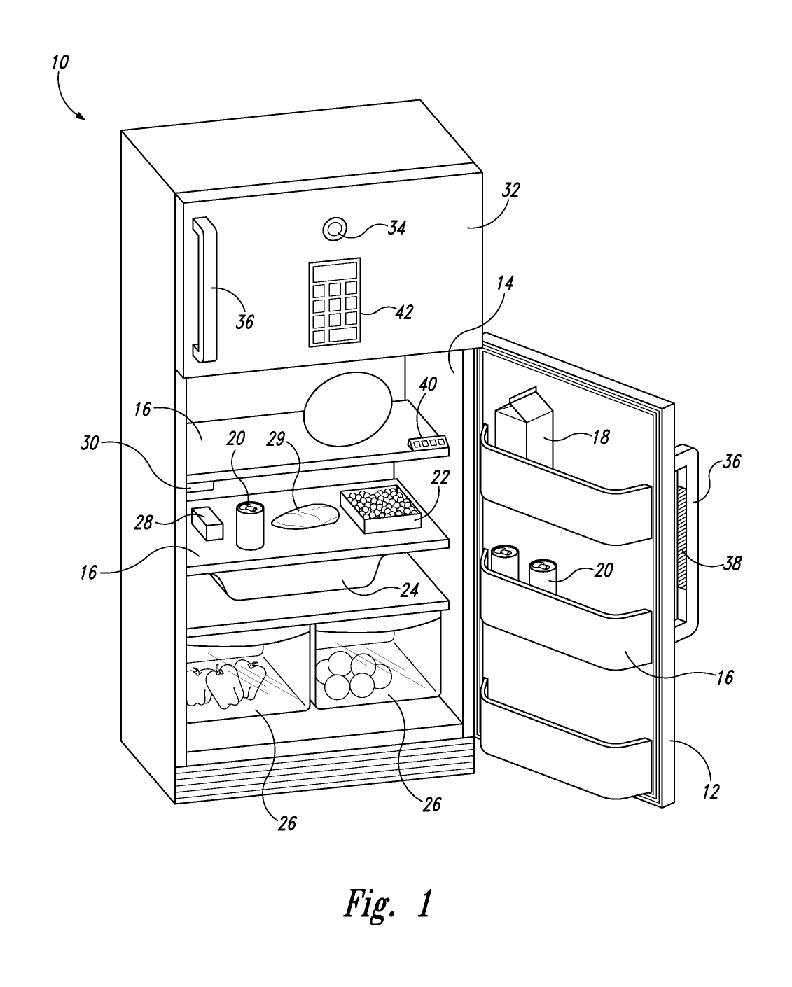

FIG. 1 is a schematic drawing showing a refrigerator 10 with information storage capabilities. Refrigerator 10 includes a door 12 configured to allow access to its interior 14. It will be understood that while the illustrated embodiment is of a refrigerator, the same design principles may be applied to a pantry, a cupboard, an icebox, or any other food storage location.

The interior compartment 14 of the refrigerator and door 12 include shelves 16, which may be instrumented as further described herein. Shelves 16 may hold standard food containers 18, or custom integrated food containers 20, 22. Custom containers may be configured to hold liquids, as shown in 20, or solids, as shown in 22, and may include instrumentation for measuring or counting their contents. For example, pitcher 20 may include apparatus for measuring the weight or volume of its contents, while box 22 may include apparatus for counting the number of raspberries placed inside it. The containers may be configured to communicate with refrigerator 10 to “tell” it how much food has been removed from them when they are accessed. Drawers 24 and 26 may also hold foods, and may be configured to maintain a weight (drawer 24) or count (drawer 26) of their food content, or both, and to communicate with refrigerator 10. These drawers 24, 26 may also be configured to provide a custom humidity or other environmental parameter as in a standard refrigerator (e.g., a fruit drawer or a meat drawer), and may include other food handling features (e.g., drainage or the like to avoid cross-contamination of leaking food packages). Shelves 16 may also store loose foods 28, 29, which may be in their original store packaging (butter 28) or repackaged in plastic wrap or the like (chicken breast 29). Shelves 16 may include a strain gage 30 or similar device for measuring the weight of foods placed on each shelf, which may optionally be displayed on a display 40. Such displays may be provided for some or all of the shelves 16.

The illustrated refrigerator 10 also includes a freezer compartment 32, and a camera 34 placed on the freezer compartment. In some embodiments, the camera may be placed in a position where it can see the user opening the freezer compartment as well as the refrigerator, or a separate camera may be placed in the freezer compartment so that the person can be identified even when the freezer door is open. One or more cameras may alternatively or in addition placed inside the refrigerator compartment. Camera 34 is configured to capture a still or moving image of a person accessing the refrigerator and in some embodiments may be activated by the person touching or moving handle(s) 36. This handle may include an integrated sensor 38, which may be used to identify a handprint of the person accessing the refrigerator in some embodiments. In some embodiments, camera 34 or handprint sensor 38 may unlock the refrigerator, possibly only if other conditions are satisfied as described below. An access pad 42 (which may be a keypad, a touchscreen, or any other suitable data-entry device) may also or alternatively be placed on the refrigerator and used to override the “lock” feature or otherwise allow access by different users.

For any of these access controls, the refrigerator 10 may compare the captured data with a database of persons known to have access to food in the refrigerator, or with a database of containers. It may further store the captured image in a log for later review by a user. Storing the image may be conditional: for example, refrigerator 10 may allow access for an unidentified person but also store his or her image for later review (and optionally also any images of food removed), while not storing images of persons who were positively identified, or it may store images of food that it determines to have been removed, but not store (or erase) images of food that is all replaced in the refrigerator. The refrigerator may include an electronic communications module configured to send a message or otherwise alert a user if it is accessed by an unknown person, or if it determines that a known user is outside of a prescribed range for a food or nutrient allotment as discussed below. For example, the electronic communications module may send a message to a particular user's medical provider if that user has consumed an excessive amount of fat or sugar on a particular day, or for a certain number of days in a month.

In use, the refrigerator “knows” the amounts (for example, by weight) of the foods inside, and can track how much is taken by any person accessing the refrigerator. For example, if butter 28 is removed from the refrigerator and then replaced inside, the refrigerator can tell by the weight before the butter is removed and after it is returned how much has been taken for consumption. In order to identify that it is the butter 28 (and not the chicken breast 29) that has been removed, the refrigerator may use camera 34 to take a picture of the food as it is being removed, used, or replaced. Alternatively, it may use an RFID reader or a bar code scanner (e.g., a scanner configured to read UPC codes) to identify foods, although in practice this may require consumers in such embodiments to affix RFID tags to their foods until it becomes standard for them to be attached at the grocery store. In some embodiments, multiple modes may be used, either together or in the alternative. For example, the refrigerator may sense an RFID tag on the box of butter 28, and infer that butter has been taken without need for the camera, but may use the camera 34 to identify that a chicken breast 29 has been removed from the shelf. In embodiments that track nutrients, refrigerator 10 may account for the weight of any discarded packaging, including parts of food that are not consumed such as orange peels and egg shells. In some embodiments, access pad 42 may be used to enter such data, including for example entering that food has been removed but not for consumption (e.g., spoiled food).

Refrigerator 10 may also provide suggestions to a user selecting food, which may be customized to the user, the time of day, the contents of the refrigerator, and the food selected by the user. For example, if the user starts to remove ice cream from the freezer compartment, refrigerator 10 may point out that there are strawberries available instead. Refrigerator 10 may also advise the user of the age of a selected (or nonselected) food, for example alerting the user when the door is opened that the strawberries have been in the refrigerator for four days and should be consumed before they rot.

In embodiments where refrigerator 10 is maintaining a log of foods consumed by different users (for example maintaining a running calorie count for each member of a family), it may include means for identifying instances in which one user prepares food for one or more others. For example, the mother of a family may indicate (e.g., using access pad 42) that she is cooking dinner for the family, and that the calories she removes from the refrigerator should be allocated equally (or in predetermined ratios) to all of the family members, or she may indicate that she is packing lunches for the children and separately allocate their calories in the log, or that she is preparing food for a potluck and that most of it will be consumed by non-family members. Refrigerator 10 may include one or more presets for these common scenarios, and a user may also manually enter information about who a food is intended for, including both household members and others such as houseguests.

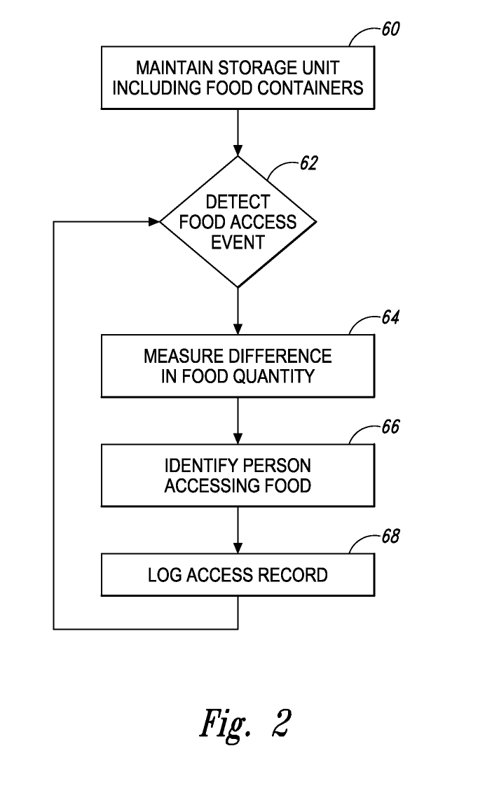

FIG. 2 is a flow chart showing a method of tracking food consumption in a household. The method includes maintaining a storage unit such as refrigerator 10 above. Upon detecting 62 a food access event (for example using camera 34 or handle sensor 38), the storage unit determines 64 how much food has been removed, identifies 66 the person removing the food, and creates 68 a log entry indicating who has removed food, how much, and optionally a timestamp. Determining 64 how much food has been removed may include communicating with an appropriate container 20, 22 or drawer 24, 26 to obtain a difference in weight, volume, or item count. Identification 66 of the person removing the food may include determining a specific identity (e.g., “Mary Smith,” “userID 4098”), or group membership (e.g., “a member of the Smith family,” “a child”) of the user. If an exact match is not (or cannot be) made, identification 66 may include assigning a new user code to the person or storing an image of the person for later identification. Creation 68 of a log entry may include storing a record of the time that food was taken, an image of the person removing the food, an image of the food or food container, or other relevant information relating to the detected food access event 62. In some embodiments, the refrigerator 10 may compare the detected user with a list of users who are authorized to access food, and lock the door so that food cannot be accessed, for example if the user is not on an “authorized” list, or if the user is on a list of people who are specifically forbidden to access food, or if the user has already accessed more food than a prescribed quantity. This feature may be used, for example, to prevent unauthorized “midnight snacking” by a user. Some medications have been reported to cause “sleep eating,” so a user may even wish to lock himself out of the refrigerator at night to prevent this. The access log may be used to count calories (or other nutrients) for one or more users as described above.

Since refrigerator 10 generally knows the quantities of different foods and how fast they are used, in some embodiments it can generate a grocery list at predetermined intervals or on demand. In some embodiments, refrigerator 10 can communicate directly with a grocery store to arrange for replacement foods to be delivered, generally with authorization and payment from a user.

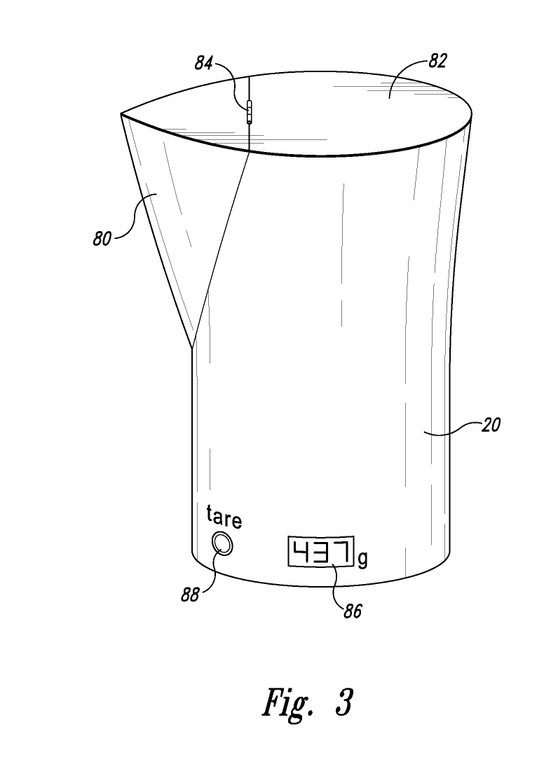

FIG. 3 is a schematic drawing of container 20 shown in FIG. 1. The illustrated container does not have a handle, but it will be understood that a handle may be included in some embodiments. Container 20 is configured for storing liquids, and includes a pour spout 80. Cover 82 is hinged with hinge 84 so that liquid can be poured from the container and it will close itself when it is returned to an upright position. The illustrated container further includes an optional readout 86 which displays a weight of how much liquid is in the container (for example, using a strain gage integrated into the base), and an optional tare button 88 which may be used to zero the weight before filling the empty container. Container 20 also includes means for communicating with refrigerator 10 to tell it the weight of the liquid in the container. This means may be an integrated transmitter, a passive RFID antenna that can be queried by the refrigerator, a physical plug in the refrigerator that the pitcher may be connected to, or any equivalent system for communicating the amount of liquid in the pitcher. In some embodiments, the pitcher may include means for detecting the fluid within or for a user to enter the type of fluid (not shown), so that the pitcher (or the refrigerator) can convert the weight of fluid to volume by using a known density. (For example, heavy cream typically has a density of about 0.994 g/ml, slightly less than that of water.)

In a general sense, the various aspects described herein which can be implemented, individually or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a computing device configured by a computer program or module (e.g., a computer configured by a computer program which at least partially carries out processes or devices described herein, or a microprocessor configured by a computer program which at least partially carries out processes or devices described herein), electrical circuitry forming a memory device (e.g., forms of random access memory), or electrical circuitry forming a communications device (e.g., a modem, communications switch, or optical-electrical equipment). The subject matter described herein may be implemented in an analog or digital fashion or some combination thereof.

The reader will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. The reader will appreciate that there are various vehicles by which processes or systems or other technologies described herein can be effected (e.g., hardware, software, or firmware), and that the preferred vehicle will vary with the context in which the processes or systems or other technologies are deployed. For example, if an implementer determines that speed and accuracy are paramount, the implementer may opt for a mainly hardware or firmware vehicle; alternatively, if flexibility is paramount, the implementer may opt for a mainly software implementation; or, yet again alternatively, the implementer may opt for some combination of hardware, software, or firmware. Hence, there are several possible vehicles by which the processes or devices or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. The reader will recognize that optical aspects of implementations will typically employ optically-oriented hardware, software, and or firmware.

The foregoing detailed description has set forth various embodiments of the devices or processes via the use of block diagrams, flowcharts, or examples. Insofar as such block diagrams, flowcharts, or examples contain at least one functions or operations, it will be understood by those within the art that each function or operation within such block diagrams, flowcharts, or examples can be implemented, individually or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as at least one computer programs running on at least one computers (e.g., as at least one programs running on at least one computer systems), as at least one programs running on at least one processors (e.g., as at least one programs running on at least one microprocessors), as firmware, or as virtually any combination thereof, and that designing the circuitry or writing the code for the software and or firmware would be well within the skill of one of skill in the art in light of this disclosure. In addition, the reader will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link, etc.).

With respect to the appended claims, any recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “indicating,” “related to,” or other past-tense adjectives are generally not intended to exclude such variants, unless context dictates otherwise.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a shelf' should typically be interpreted to mean “at least one shelf'); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two shelves,” or “a plurality of shelves,” without other modifiers, typically means at least two shelves). Furthermore, in those instances where a phrase such as “at least one of A, B, and C,” “at least one of A, B, or C,” or “an article selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A1, A2, and C together, A, B1, B2, C1, and C2 together, or B1 and B2 together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Moreover, “can” and “optionally” and other permissive terms are used herein for describing optional features of various embodiments. These terms likewise describe selectable or configurable features generally, unless the context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A food storage system, comprising:
a storage unit configured to hold a plurality of food containers;
an identification unit configured to passively determine an identity of a person accessing the storage unit; and
a memory configured to store a log, the log including a plurality of entries of food acquisition incidents.

2. (canceled)

3. (canceled)

4. The food storage system of claim 1, wherein the identification unit includes a camera, and wherein the camera is configured to image a person accessing the storage unit.

5. The food storage system of claim 4, wherein the camera is located within the storage unit.

6. The food storage system of claim 4, wherein the identification unit is configured to use the image of the person accessing the storage unit to identify the person.

7.-9. (canceled)

10. The food storage system of claim 4, wherein the identification unit is configured to use the image of the person accessing the storage unit to identify a type of food removed.

11. (canceled)

12. (canceled)

13. The food storage system of claim 4, wherein the identification unit is configured to use the image of the person accessing the storage unit to identify a quantity of food removed.

14. The food storage system of claim 1, wherein the identification unit includes a handprint scanner.

15. The food storage system of claim 14, wherein the handprint scanner is placed on a handle of the storage unit.

16. The food storage system of claim 1, wherein the identification unit includes an RFID reader, wherein the RFID reader is configured to identify an accessed food container.

17. The food storage system of claim 1, wherein if the identification unit is unable to determine the identity of a person accessing the storage unit, the system is configured to store an image of the person in the log.

18. The food storage system of claim 1, wherein the log includes an access time, the identity of the person accessing the unit, and a food removed.

19. The food storage system of claim 18, wherein at least one container of the plurality of food containers includes a counter configured to maintain a status reflecting an amount of food in the container, and wherein a corresponding log entry designates a difference in the status as the food removed.

20. -25. (canceled)

26. The food storage system of claim 1, wherein each log entry includes a user ID and a food type.

27.-29. (canceled)

30. The food storage system of claim 1, further comprising a processor configured to generate a running total of a nutrient removed from the storage unit.

31. (canceled)

32. The food storage system of claim 30, wherein the processor is configured to generate a running total of the nutrient for at least one user ID of a plurality of user IDs.

33. The food storage system of claim 32, wherein the processor is configured to generate a report if the running total exceeds or falls short of a target value.

34.-37. (canceled)

38. The food storage system of claim 1, wherein the memory is configured to store logs for a plurality of storage units.

39. The food storage system of claim 1, further comprising a processor configured to access the log from the memory, to edit the log by adding or by modifying a log entry, and to return the edited log to memory.

40. The food storage system of claim 1, further comprising a lock configured to prevent access to the storage unit.

41. The food storage system of claim 40, wherein the lock is configured to prevent access if the identification unit is unable to determine the identity of a person attempting to access the storage unit.

42. The food storage system of claim 40, wherein the lock is configured to prevent access by a particular person.

43. (canceled)

44. (canceled)

45. The food storage system of claim 1, wherein at least one container of the plurality of food containers includes a lock configured to prevent access to food inside the container.

46.-50. (canceled)

51. The food storage system of claim 1, further comprising a processor configured to monitor a quantity of food in the storage unit.

52. (canceled)

53. The food storage system of claim 1, further comprising a processor configured to provide a suggestion to a person accessing the storage unit.

54. (canceled)

55. (canceled)

56. The food storage system of claim 1, further comprising an electronic communications module.

57.-59. (canceled)

60. A method of recording food consumption, comprising:
maintaining a storage unit holding a plurality of food containers;
passively determining identity of a person accessing the storage unit; and
making an entry in a log including a record of a food acquisition incident.

61. (canceled)

62. The method of claim 60, wherein passively determining identity of the person accessing the storage unit includes imaging the person.

63. The method of claim 62, wherein imaging the person includes using a camera located inside the storage unit.

64. The method of claim 62, wherein passively determining identity of the person accessing the storage unit includes using facial recognition techniques to compare the image with a list of persons known to have permission to access the storage unit.

65. (canceled)

66. (canceled)

67. The method of claim 62, wherein passively determining identity of the person accessing the storage unit includes using handprint recognition techniques to compare the image with a list of persons known to have permission to access the storage unit.

68. The method of claim 62, wherein imaging the person further includes identifying a type of food removed.

69. The method of claim 62, wherein imaging the person further includes identifying a quantity of food removed.

70. The method of claim 60, wherein passively determining identity of the person accessing the storage unit includes using a handprint scanner to identify the person.

71. (canceled)

72. The method of claim 60, wherein making an entry in the log includes recording an access time, the identity of the person accessing the unit, and a food removed.

73. The method of claim 72, wherein at least one container of the plurality of food containers includes a counter configured to maintain a status reflecting an amount of food in the container, and wherein making an entry in the log includes storing an amount of food removed from the container as determined by the counter.

74. The method of claim 72, wherein at least one container of the plurality of food containers includes means for determining an amount of food dispensed from the container, and wherein making an entry in the log includes storing an amount of food dispensed from the container.

75. The method of claim 60, wherein making an entry in the log includes allowing a user to manually enter a different user ID.

76. The method of claim 60, further comprising generating a running total of a nutrient in foods removed from the storage unit.

77. (canceled)

78. (canceled)

79. The method of claim 60, wherein the storage unit includes a lock, and further comprising unlocking the storage unit upon identification of a person attempting to access the storage unit as an authorized user.

80. The method of claim 60, wherein the storage unit includes a lock, and further comprising keeping the storage unit locked if a person attempting to access the storage unit is identified as an unauthorized user.

81. The method of claim 60, wherein the storage unit includes a lock, and further comprising keeping the storage unit locked if a person attempting to access the storage unit cannot be identified.

82. (canceled)

83. The method of claim 60, wherein the storage unit includes a lock, and further comprising keeping the storage unit locked based on a history of access by a person attempting to access the storage unit.

84. The method of claim 60, further comprising monitoring a quantity of food in the storage unit.

85. The method of claim 84, further comprising predicting a time when the monitored quantity will fall below a threshold, and outputting the monitored food to a grocery list at or before that time.

86. The method of claim 60, further comprising suggesting a food to a person accessing the unit.

87. The method of claim 86, wherein the food suggested is based at least in part on the passively determined identity of the person accessing the storage unit.

88. The method of claim 86, wherein the food suggested is based at least in part on a food selection made by the person accessing the storage unit.

89. A food container for use with a food storage unit, comprising:
a container configured to hold a food;
a sensor configured to determine a quantity of food in the container; and
communication means configured to notify the food storage unit of changes in the quantity of food in the container.

90. (canceled)

91. (canceled)

92. The food container of claim 89, wherein the sensor is configured to determine weight of the food.

93. The food container of claim 89, wherein the sensor is configured to count a number of the food.

94. The food container of claim 89, wherein the communication means is configured to transmit a message to the storage unit.

95. The food container of claim 89, wherein the communication means is configured to be passively interrogated by the storage unit.
